(19) United States
(12) Patent Application Publication
(10) Pub. No.: US 2023/0289755 A1
(43) Pub. Date: Sep. 14, 2023

(54) METHOD AND APPARATUS FOR REMITTANCE SERVICE

(71) Applicant: KAKAO CORP., Jeju-si (KR)

(72) Inventors: Jee Won YOU, Seongnam-si (KR); Young Min PARK, Seongnam-si (KR); Min Joung CHOI, Seongnam-si (KR); Se In PARK, Seongnam-si (KR); Su Ok SONG, Seongnam-si (KR)

(21) Appl. No.: 18/182,407

(22) Filed: Mar. 13, 2023

(30) Foreign Application Priority Data
Mar. 14, 2022 (KR) 10-2022-0031669

(51) Int. Cl. G06Q 20/10; G06Q 20/22; G06Q 20/40

(52) U.S. Cl. CPC G06Q 20/108; G06Q 20/2295; G06Q 20/4014

(57) ABSTRACT

A method and apparatus for a remittance service are disclosed. An operation method of a server providing a remittance service includes generating a family account including at least one of an administrator account and at least one member account in response to a request to generate the family account, receiving, from a terminal of the administrator account, a request to set a remittance condition for the at least one member account, and processing a remittance request of the at least one member account, based on the remittance condition set for the at least one member account.

### CROSS-REFERENCE TO RELATED APPLICATION(S)

This application claims the priority benefit of Korean Patent Application No. 10-2022-0031669 filed on Mar. 14, 2022, in the Korean Intellectual Property Office, the disclosure of which is incorporated herein by reference for all purposes.

### BACKGROUND

### 1. Field

One or more embodiments relate to a method and apparatus for a remittance service, and more particularly, to a server for providing a remittance service and a client using the remittance service.

### 2. Description of Related Art

Financial technology (FinTech) is the compound word of finance and technology and refers to financial services and industries based on information technology, including mobile, big data, social networking services (SNS), and the like. Various financial services using FinTech have emerged. These financial services are different from existing financial services and include mobile banking, app cards, and the like. With the recent expansion of FinTech services, a user may directly deal with banking activities, such as transfers or deposits, by using a computer or a mobile device without visiting a bank, and online remittance services are widely used. The use of an official authentication certificate or the exchange of personal information, such as a name of a remittee, a bank name of the remittee, and an account number of the remittee, and the like, was necessary for using online remittance services, but recently, technologies for providing convenient online remittance services have been actively developed, for example, by simplifying an authentication process or by simplifying information necessary for a remittance transaction.

### SUMMARY

An aspect provides technology for managing the use of a remittance service of an account of a ward by an account of a guardian, based on a family account, that is, a group of user accounts.

Another aspect also provides technology for managing the use of a remittance service of an account of a ward in a certain type of chatroom by an account of a guardian, based on a family account, that is, a group of user accounts.

However, technical aspects are not limited to the foregoing aspect, and there may be other technical aspects.

According to an aspect, there is provided a method of providing a remittance service by a messaging server for providing a messaging service by interoperating with a remittance server, the method including: receiving, from a terminal of a first user account subscribing to the messaging service, a remittance request to a second user account subscribing to the messaging service; determining whether the first user account is under a family account when the first user account is an account of a ward; determining whether remittance is allowed to the first user account, based on a remittance condition set for the first user account under the family account; and transmitting the remittance request to the remittance server when remittance is allowed.

The determining whether the first user account is under the family account may include determining whether the first user account is under the family account, based on a type of chatroom through which the remittance request is received.

The determining whether the first user account is under the family account may include determining whether the first user account is under the family account, based on a profile type of the second user account designated as a remittee of the remittance request.

The method may further include receiving, from the remittance server, remittance transaction information corresponding to the remittance request generated based on a remittance limit set for the first user account by the family account.

The remittance condition may be set for a member account of the family account by an administrator account of the family account.

The determining whether remittance is allowed may include determining whether remittance is allowed through a chatroom through which the remittance request is received, based on the remittance condition on whether remittance is allowed and determining whether a remittance amount included by the remittance request is allowed to be remitted, based on the remittance condition on a remittance limit.

The method may further include receiving, from the remittance server, remittance transaction information including the second user account as a remittee and transmitting a remittance notification message to the second user account, based on the remittance transaction information.

According to another aspect, there is provided an operation method of a server providing a remittance service including: generating a family account including at least one of an administrator account and at least one member account in response to a request to generate the family account; receiving, from a terminal of the administrator account, a request to set a remittance condition for the at least one member account; and processing a remittance request of the at least one member account, based on the remittance condition set for the at least one member account.

The administrator account may include an account of a guardian authenticated as an adult, and the at least one member account may include an account of a ward.

The generating the family account may include authenticating whether a user account requesting the generation of the family account is an adult; generating the family account including the adult authenticated user account as the administrator account; transmitting an invitation request to a terminal of a user account designated as the at least one member account of the family account by the administrator account; and adding a user account accepting the invitation request as the at least one member account of the family account.

The remittance condition may include whether to allow remittance through a preset type of chatroom; a remittance limit amount per day through the preset type of chatroom; and a remittance limit amount per remittance through the preset type of chatroom.

According to another aspect, there is provided a messaging server providing a remittance service by interoperating with a remittance server including: at least one processor configured to receive, from a terminal of a first user account subscribing to a messaging service, a remittance request to a second user account subscribing to the messaging service, determine whether the first user account is under a family account when the first user account is an account of a ward; determine whether remittance is allowed to the first user account, based on a remittance condition set for the first user account under the family account; and transmitting the remittance request to the remittance server when remittance is allowed.

When determining whether the first user account is under the family account, the processor may determine whether the first user account is under the family account, based on a type of chatroom through which the remittance request is received.

When determining whether the first user account is under the family account, the processor may determine whether the first user account is under the family account, based on a profile type of the second user account designated as a remittee of the remittance request.

The processor may receive, from the remittance server, remittance transaction information corresponding to the remittance request generated based on a remittance limit set for the first user account by the family account.

The remittance condition may be set for a member account of the family account by an administrator account of the family account.

When determining whether remittance is allowed, the processor may determine whether remittance is allowed through a chatroom through which the remittance request is received, based on the remittance condition on whether remittance is allowed, and determine whether a remittance amount included by the remittance request is allowed to be remitted, based on the remittance condition on a remittance limit.

The processor may receive, from the remittance server, remittance transaction information including the second user account as a remittee and transmit a remittance notification message to the second user account, based on the remittance transaction information.

According to an aspect, there is provided a server providing a remittance service including: at least one processor configured to generate a family account including at least one of an administrator account and at least one member account in response to a request to generate the family account, receive, from a terminal of the administrator account, a request to set a remittance condition for the at least one member account, and process a remittance request of the at least one member account, based on the remittance condition set for the at least one member account.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a flowchart illustrating an operation method of a server providing a remittance service, according to an embodiment.

FIGS. 2A to 2C are diagrams illustrating an interface screen for managing a family account provided to a terminal of an administrator account of the family account, according to an embodiment.

FIGS. 3A to 3D are diagrams illustrating an interface screen for managing a family account provided to a terminal of a member account of the family account, according to an embodiment.

FIG. 4 is a diagram illustrating a remittance system according to an embodiment.

FIG. 5 is a flowchart illustrating a method of providing a remittance service by a messaging server by interoperating with a remittance server, according to an embodiment.

FIG. 6 is a diagram illustrating an operation of a server for processing a remittance request in response to receiving the remittance request, according to an embodiment.

FIGS. 7A and 7B are diagrams each illustrating a remittance notification message on a remittance failure, according to an embodiment.

FIG. 8 is a diagram illustrating a configuration of a server according to an embodiment.

### DETAILED DESCRIPTION

The following detailed structural or functional description is provided as an example only and various alterations and modifications may be made to embodiments. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like elements and a repeated description related thereto is omitted.

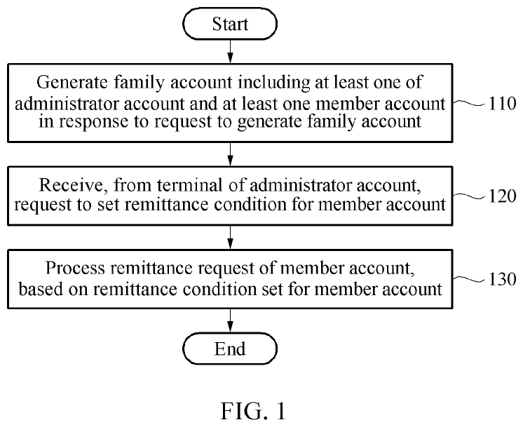

FIG. 1 is a flowchart illustrating an operation method of a server providing a remittance service, according to an embodiment.

Referring to FIG. 1, the operation method of the server providing a remittance service includes generating a family account including at least one of an administrator account and at least one member account in response to a request to generate the family account in operation 110, receiving, from a terminal of the administrator account, a request to set a remittance condition for the at least one member account in operation 120, and processing a remittance request of the at least one member account, based on the remittance condition set for the at least one member account, in operation 130.

The server may be a server providing a remittance service and may generate and manage the accounts of users subscribing to the remittance service and provide a service of remitting and receiving a certain amount by using the accounts of users. For example, the accounts of users may be bank accounts or online accounts, in which the online accounts store virtual electronic currencies having a certain monetary value.

According to an embodiment, the server may provide a messaging service that receives or transmits messages between users subscribing to the service or transmitting a notification message to a subscribing user. The server may provide a messaging service based on an instant message transmitted or received through a messenger application installed on a terminal of a subscribing user or may provide a messaging service based on a short message service (SMS) provided by a mobile communication service provider.

According to an embodiment, the server may provide a remittance service through a messenger application. For example, a user subscribing to the service may request the server by using the messenger application to remit a certain amount to another user, and the server may process the received remittance request.

According to an embodiment, the remittance service and the messaging service may be provided by different servers. For example, the server may include a messaging server for providing the messaging service and a remittance server for providing the remittance service. The example of the server divided into the messaging server and the remittance server is described in detail below.

The server may generate an account corresponding to a user who requests a subscription, and a client logging in to the generated account may use a service provided by the server. The client may include a terminal (or a terminal of a user account) of a user logging in to an account of the service provided by the server.

According to an embodiment, the server may generate an account based on real name information of the user requesting a subscription. For example, the server may generate the account of the user, based on authenticated real name information of the user requesting a subscription and/or a mobile phone number under the real name of the user requesting a subscription. Accounts may be a unit for identifying, by a server, a user subscribing to a service.

According to an embodiment, user accounts subscribing to a service may be grouped into a family account. The family account may be a group of a plurality of user accounts in a certain relationship, for example, a group including a plurality of user accounts in a parent and child relationship, a group of a plurality of user accounts in a guardian and ward relationship, and/or a group of a plurality of user accounts in an administrator and subject to administration relationship.

According to an embodiment, the family account may include at least one of an administrator account and at least one member account. The administrator account may be a user of which an administrator qualification is authenticated and may include, for example, an account of a guardian authenticated as an adult. The member account may be a user account that is not the administrator account among user accounts included by the family account and may include an account of a ward, including, for example, a minor, a person with deficiency in abilities and/or a person with limited capacity. The account of a guardian and the account of a ward may include user accounts in a legal guardian and ward relationship, such as parents and their minors, and in a guardian and ward relationship by contract. For example, the account of a ward may include an account of a minor, and the account of a minor may be determined based on an actual age of a user of real name information input when subscribing to a service. The administrator account of the family account may set a condition for service use, such as a remittance condition, for the member account of the family account.

Operation 110 may include generating the family account in response to a request to generate the family account received from a terminal of a certain user account subscribing to a service. For example, a user account of which an administrator qualification is verified may request the server to generate the family account. The administrator qualification may be verified through adult authentication. The user account, of which an administrator qualification is verified, that requests the generation of the family account may be designated as the administrator account of the generated family account. A terminal of the administrator account of the generated family account may invite another user account to the member account of the family account, and a user account accepting the invitation may be added to the member account of the family account. In other words, operation 110 may include authenticating whether the user account requesting the generation of the family account is an adult, generating the family account including the adult authenticated user account as the administrator account, transmitting an invitation request to a terminal of the user account designated as the at least one member account of the family account by the administrator account, and adding the user account accepting the invitation request as the at least one member account of the family account.

According to an embodiment, a user account of which an administrator qualification is not authenticated may designate at least one user account of which an administrator qualification is verified as an administrator of the family account and request the generation of the family account.

Operation 120 may include receiving a request to set respective remittance conditions for respective member accounts of the family account from the terminal of the administrator account of the generated family account. For example, a remittance condition may include whether to allow remittance through a preset type of chatroom, a remittance limit amount per day through the preset type of chatroom, and a remittance limit amount per remittance through the preset type of chatroom.

According to an embodiment, the preset type of chatroom may include an anonymous chatroom. The anonymous chatroom may be a chatroom in which a user participates by using a temporary profile, not a real-name-based account. For example, the anonymous chatroom service may include an open chat service (a registered trademark of Kakao Corp.) provided by Kakao, that is, the applicant of the present disclosure, and more specifically, a non-acquaintance-based open chat service provided by a KakaoTalk application of the applicant of the present disclosure. The anonymous chatroom may mean a chatroom of the open chat service provided by Kakao, that is, the applicant of the present disclosure. The open chat service provided by Kakao is an example of an anonymous chatroom service, and examples are not limited thereto. The anonymous chatroom service may include a service providing a chatroom in which the user participates by using a temporary profile, not a real-name-based account. The temporary profile may be a profile temporarily assigned to the account of the user and may include, as identification information, a temporary name input by the user or a name temporarily generated by the server, not a real name. In other words, the anonymous chatroom may be a chatroom in which the user may participate by using a temporarily generated profile without exposing an account based on the real name of the user. The anonymous chatroom may be used for a chat between users who do not share their accounts, which is different from a general chatroom for a chat between users who know the accounts of one another. The anonymous chatroom may include a form of a 1:1 chatroom or a form of a group chatroom including two or more users as participants.

The preset type of chatroom may not be limited to the anonymous chatroom and may include various types of chatrooms, such as a chatroom in which real-name based accounts participate, a chatroom in which users are friends who know each other's account information, or the like.

According to an embodiment, remittance conditions may be set by types of chatrooms. For example, when setting a remittance condition for a member account, the administrator account of the family account may set different remittance conditions respectively corresponding to a first type of chatroom and a second type of chatroom.

According to an embodiment, when receiving a remittance request from the member account through operation 130, the server may process the remittance request based on the remittance condition set for the member account. For example, when a condition that does not allow remittance through a certain chatroom (e.g., the anonymous chatroom) is set for the member account, the server may not process the remittance request from the member account through the chatroom. As another example, when the remittance request from the member account exceeds a set remittance limit, the server may not process the remittance request from the member account. When the remittance request from the member account is not processed, based on the remittance condition, the server may transmit, to the member account, the message notifying that remittance is not processed. The detailed operation of the server processing a remittance request based on remittance conditions is described in detail below.

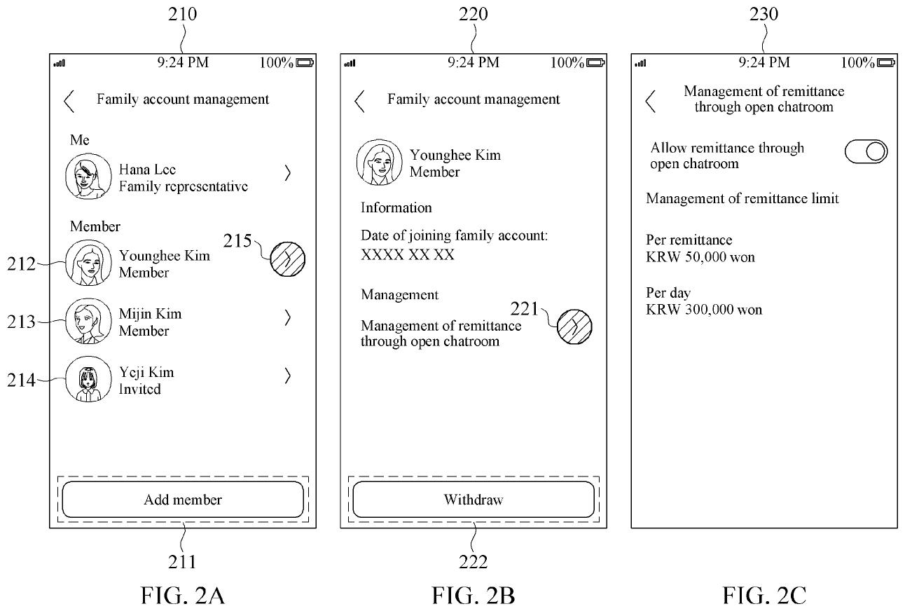

FIGS. 2A to 2C are diagrams illustrating an interface screen for managing a family account provided to a terminal of an administrator account of the family account, according to an embodiment.

Referring to FIG. 2A, the terminal of the administrator account of the family account (hereinafter referred to as an administrator) may be provided with an interface 210 for managing the family account. The administrator may request a server to add a member account of the family account through an interfacing object 211 for adding the member account of the family account in the interface 210. An interfacing object may be an object implemented to perform a preset operation in response to a user's input and may include, for example, a button for calling another interface in response to the user's click input. The server may transmit an invitation request of the family account to a terminal of a user account designated as the member account. Member accounts 212 and 213 accepting the invitation may be added to the member account of the family account. A user account 214 to which an invitation request is transmitted but is yet to be accepted may be displayed as an ‘invited’ state to distinguish the user account 214 from other member accounts.

According to an embodiment, an administrator may enter an interface (e.g., an interface 220 of FIG. 2B) for managing each of the member accounts through an interfacing object 215 for managing a member account. Referring to FIG. 2B, the interface 220 for managing a member account may be provided to the terminal of the administrator account. The interface 220 may include date information on when the member account joins the family account and an interfacing object 221 for setting a remittance condition. For example, the administrator may withdraw the member account from the family account through an interfacing object 222 for withdrawing a member account from a family account, and the account withdrawn by the administrator may no longer be the member account joining the family account.

According to an embodiment, the administrator may enter an interface (e.g., an interface 230 of FIG. 2C) for setting a remittance condition for a member account through the interfacing object 221 for setting a remittance condition for a member account. Referring to FIG. 2C, the interface 230 for setting a remittance condition for a member account may be provided to the terminal of the administrator account. The administrator may set whether to allow remittance through a preset type of chatroom (e.g., an anonymous chatroom or an open chatroom) and set a remittance limit per remittance and a remittance limit per day through the preset type of chatroom (e.g., the anonymous chatroom or the open chatroom).

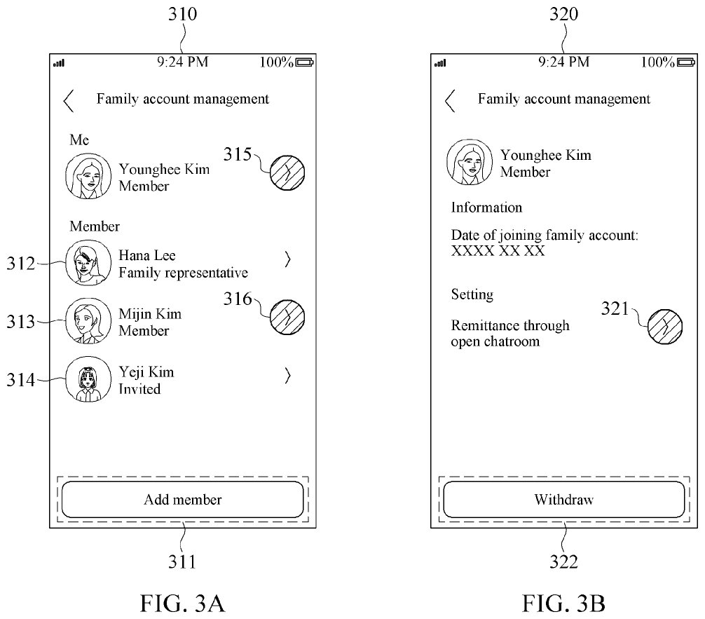

FIGS. 3A to 3D are diagrams illustrating an interface screen for managing a family account provided to a terminal of a member account of the family account, according to an embodiment.

Referring to FIG. 3A, an interface 310 for managing a family account may be provided to the terminal of the member account of the family account (hereinafter referred to as a member). The member may request a server to add an administrator account of the family account or a member account through an interfacing object 311 for adding a member account of the family account in the interface 310. The server may transmit an invitation request of the family account to a terminal of a user account designated as the administrator account or the member account. Member accounts 312 and 313 accepting the invitation may be added to the administrator account or the member account of the family account. For example, when the administrator account of the family account has already been added, the server, based on the permission of the administrator account, may transmit an invitation request to a terminal of a user account to be invited or add a user account accepting the invitation to the member account. A user account 314 to which an invitation request is transmitted but is yet to be accepted may be displayed as an ‘invited’ state to distinguish the user account 314 from other member accounts.

According to an embodiment, the member may enter an interface (e.g., an interface 320 of FIG. 3B) for managing the member account of its own through an interfacing object 315 for managing a member account of its own. Referring to FIG. 3B, the interface 320 for managing a member account of its own may be provided to the terminal of the member account. The interface 320 may include date information on when the member account joins the family account and an interfacing object 321 for checking a remittance condition. For example, the member may request a withdrawal from the joined family account through an interfacing object 322 for withdrawing from a family account. The member account may withdraw from the family account through a withdrawal request, and when withdrawing from the family account, the account may no longer be the member account joining the family account. For example, a withdrawal process regarding the withdrawal request from the member account may be completed based on an approval of withdrawal by the administrator account.

According to an embodiment, the member may enter an interface (e.g., an interface 330 of FIG. 3C) for checking a remittance condition for a member account of its own through the interfacing object 321 for checking a remittance condition for a member account of its own. Referring to FIG. 3C, the interface 330 for checking a remittance condition for a member account of its own may be provided to the terminal of the member account. The member may check whether remittance through a preset type of chatroom (e.g., an anonymous chatroom or an open chatroom) is allowed and check a remittance limit per remittance and a remittance limit per day through the preset type of chatroom (e.g., the anonymous chatroom or the open chatroom).

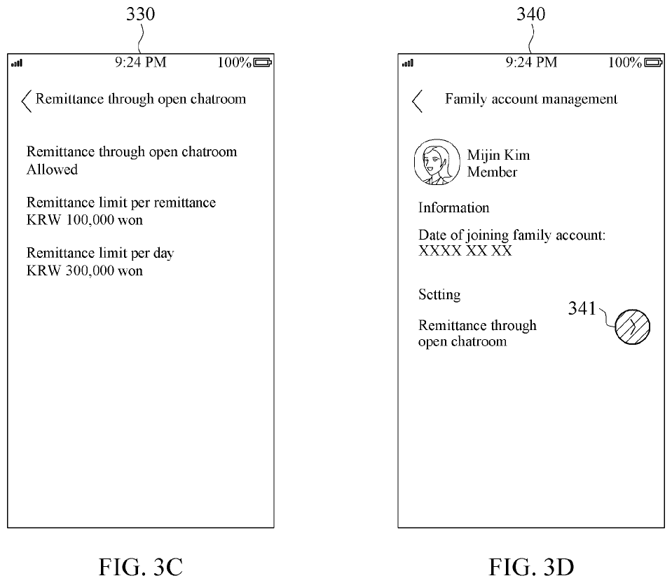

Referring to FIG. 3A, the member may enter an interface (e.g., an interface 340 of FIG. 3D) for referring to another member account or an administrator account of a family account through an interfacing object 316 for referring to another member account or an administrator account of a family account. Referring to FIG. 4D, the member may refer to information on another member account or the administrator account through the interface 340 and enter an interface for checking a remittance condition set for an account through an interfacing object 341.

FIG. 4 is a diagram illustrating a remittance system according to an embodiment. The server providing the remittance service described above with reference to FIG. 1 may include a messaging server 410 and a remittance server 420. Referring to FIG. 4, the remittance system may include the messaging server 410, the remittance server 420, and a client 430. The messaging server 410 and the remittance server 420 may interoperate and include a device providing a remittance service. The client 430 may include a terminal of a user of the remittance service provided by the messaging server 410 and the remittance server 420.

The messaging server 410 may be a server providing a messaging service, which may transmit or receive messages between users subscribing to a service provided by the messaging server 410 or provide a messaging service for transmitting a notification message to a subscribing user.

For example, a message may be transmitted to an account of a user designated as a recipient in the messaging server 410, and messages transmitted and received in a chatroom or a list of chatrooms in which the user participates may be stored corresponding to the account of the user. The client 430 may set an account of the client 430 and an account of another user to be friends and may transmit and receive messages to and from the account of the other user set to be a friend through the messaging server 410.

According to an embodiment, the messaging server 410 may provide a messaging service to a user subscribing to another service linked with the messaging server 410, besides a user subscribing to the messaging service. The client 430 may log in to another service linked with the messaging server 410 and use a service provided by the messaging server 410. The messaging server 410 may provide an anonymous chatroom service.

The remittance server 420 may be a server interoperating with the messaging server 410 and providing a remittance service and may generate and manage the accounts of users subscribing to the remittance service and provide a service of remitting and receiving a certain amount by using the accounts. For example, the remittance server 420 may include an online banking server of a bank and an online banking server providing a remittance service through an application.

According to an embodiment, the remittance server 420 may generate an account corresponding to a user requesting a subscription, and the client 430 logging in to the generated account may use a service provided by the remittance server 420. According to an embodiment, an account corresponding to the messaging server 410 of a user and an account corresponding to the remittance server 420 of the same user may be linked with each other. For example, the messaging server 410 may identify the account corresponding to the messaging server 410 from the account corresponding to the remittance server 420, and the remittance server 420 may identify the account corresponding to the remittance server 420 from the account corresponding to the messaging server 410.

According to an embodiment, the messaging server 410 may interoperate with the remittance server 420 and provide a remittance service. For example, the messaging server 410 may provide a user subscribing to a messaging service with a function of requesting the remittance server 420 for a remittance to an account of another user through a messaging application or a chatroom interface and a function of requesting the receipt of an amount remitted from the account of the other user therethrough. The remittance server 420 may identify a remitter requesting the messaging server 410 for a remittance and a remittee of the requested remittance and may process a remittance transaction between an account of the remitter and an account of the remittee that are provided by the remittance server 420. The messaging server 410 may transmit, to an account of a user, a message on a remittance transaction processed by the remittance server 420. In other words, the messaging server 410 may interoperate with the remittance server 420 and provide a remittance service to the client 430 logging in to the generated account. According to an embodiment, the messaging server 410 may interoperate with the remittance server 420 and provide a remittance service for requesting the remittance server 420 for a remittance by designating, as a remittee, another participant whose account information is not identified in an anonymous chatroom.

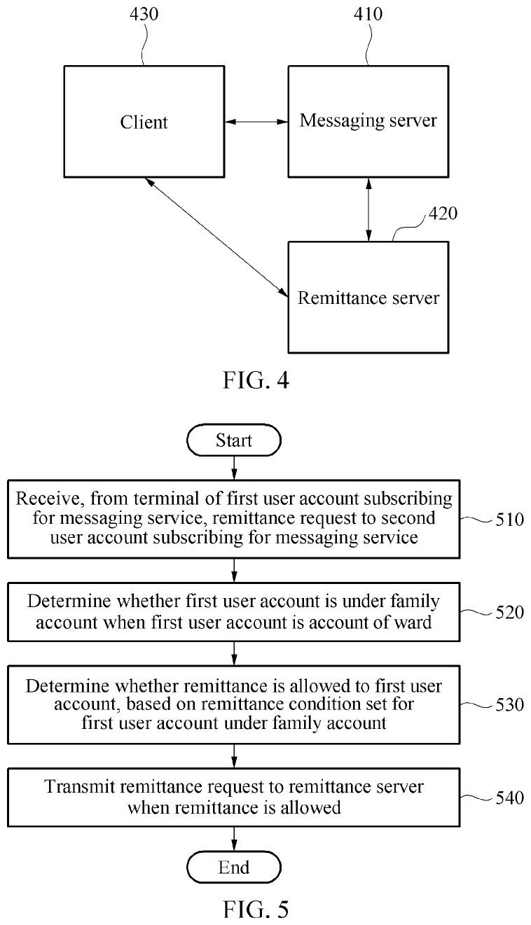

FIG. 5 is a flowchart illustrating a method of providing a remittance service by a messaging server by interoperating with a remittance server, according to an embodiment.

According to an embodiment, the method of providing a remittance service by the messaging server for providing a messaging service by interoperating with the remittance server may include receiving, from a terminal of a first user account subscribing to the messaging service, a remittance request to a second user account subscribing to the messaging service in operation 510, determining whether the first user account is under a family account, in operation 520, when the first user account is an account of a ward, determining whether remittance is allowed to the first user account, in operation 530, based on a remittance condition set for the first user account under the family account, and transmitting the remittance request to the remittance server, in operation 540, when remittance is allowed.

In operation 510, the first user account may be a remitter and the second user account may be a remittee. The remittance request may be received through a chatroom in which the first user account and the second user account participate. For example, the first user account and the second user account may participate in an anonymous chatroom by using a temporary profile, and the remittance request designating a temporary profile of the second user account as the remittee may be received from a terminal of the first user account through the anonymous chatroom. As another example, the remittance request may be received through a general chatroom in which the first user account and the second user account participate by using a real-name-based profile, or the remittance request may be received together with information of the second user account registered as a friend relationship in the first user account without through a chatroom.

According to an embodiment, the messaging server may determine whether the first user account requesting remittance is an account of a ward in response to the remittance request received from a terminal of the first user account. Whether to be an account of a ward may be determined based on real name information of a subscribing account. For example, when a user of an account is a minor according to age information included by the real name information of the subscribing account, the account may be determined to be an account of a ward. When a user account requesting remittance is an account of a ward, the messaging server may determine whether the user account is under a family account.

Operation 510 may include an operation of determining whether the first user account, that is, an account of a ward, is under a family account, based on a type of chatroom in which the remittance request is received. For example, when the remittance request is received in a preset certain type of chatroom, whether the first user account, that is, an account of a ward, requesting remittance is under the family account may be determined. For example, when a first type of chatroom receives the remittance request from the first user account, the messaging server may determine whether remittance is allowed after determining that the first user account is under the family account. In addition, when a second type of chatroom receives the remittance request from the first user account, remittance may be allowed regardless of whether the first user account is under the family account. For example, the first type of chatroom may be an anonymous chatroom and the second type of chatroom may be another type of chatroom (e.g., a general chatroom in which a user participates by using a real-name-based profile) other than the anonymous chatroom.

Operation 520 may include an operation of determining whether the first user account, that is, an account of a ward, is under a family account, based on a profile type of the second user account designated as a remittee of the remittance request. For example, when the remittance request designating the preset certain type of profile as a remittee is received, whether the first user account, that is, an account of a ward, requesting remittance is under the family account may be determined. For example, when receiving the remittance request designating a first type of profile as a remittee from the first user account, the messaging server may determine whether remittance is allowed after determining that the first user account is under the family account. In addition, when receiving the remittance request designating a second type of profile as a remittee from the first user account, remittance may be allowed regardless of whether the first user account is under the family account. For example, the first type of profile may be a temporary profile, and the second type of profile may be a real-name-based profile.

According to an embodiment, a remittance condition may be set for the first user account under the family account. The remittance condition may be set for a member account of the family account by an administrator account of the family account. As described above, the remittance condition may include whether to allow remittance through a preset type of chatroom, a remittance limit amount per day through the preset type of chatroom, and a remittance limit amount per remittance through the preset type of chatroom.

Operation 530 may include an operation of determining whether the remittance request is allowed, based on the remittance condition set for the first user account under the family account. For example, operation 530 may include determining whether remittance is allowed through a chatroom through which the remittance request is received, based on the remittance condition on whether remittance is allowed and determining whether a remittance amount included by the remittance request is allowed to be remitted, based on the remittance condition on a remittance limit.

For example, the remittance condition on whether remittance is allowed may include remittance conditions on whether remittance is allowed set by the types of chatrooms. For example, the remittance condition on a remittance limit may include a condition on a remittance amount per day and/or a remittance amount per remittance, and the remittance condition on a remittance limit may also be set by the types of chatrooms. A remittance permission state, including at least one of whether remittance is allowed corresponding to a type of chatroom in which a remittance request is received, a remittance limit amount per day corresponding to the type of chatroom in which the remittance request is received, and a remittance limit amount per remittance corresponding to the type of chatroom in which the remittance request is received, may be determined.

According to an embodiment, when the first user account, that is, an account of a ward, is not under the family account, the remittance condition may not be set, and the remittance request may always be allowed or may always not be allowed.

Operation 540 may include an operation of transmitting the remittance request when determining that remittance is allowed and not transmitting the remittance request when determining that remittance is not allowed.

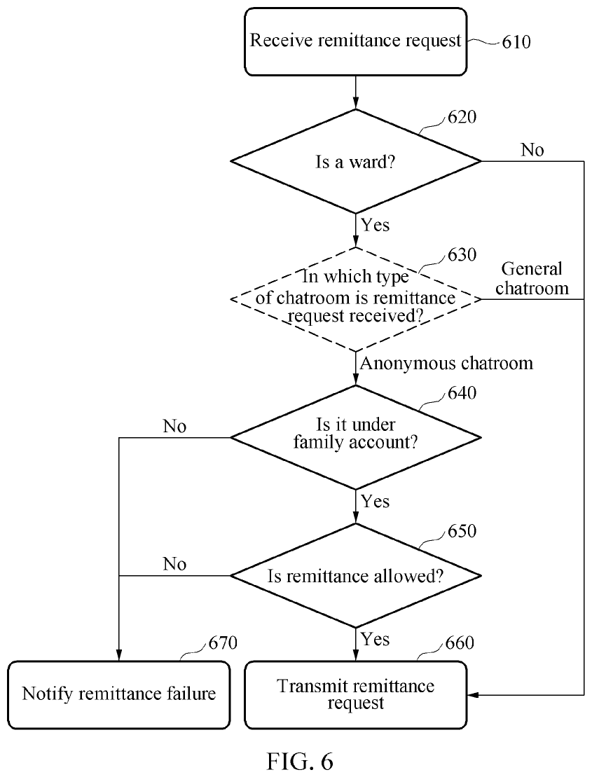

For example, referring to FIG. 6, the messaging server may determine, in operation 620, whether the first user account requesting remittance is an account of a ward in response to the remittance request received in operation 610 from a terminal of the first user account. When the first user account is an account of a ward, the messaging server may determine, in operation 640, whether the first user account is under a family account.

According to an embodiment, the messaging server may determine whether the first user account is under the family account, based on a type of chatroom in which the remittance request is received. For example, the type of chatroom in which the remittance request is received may be determined in operation 630. When determining that the type of chatroom in which the remittance request is received is an anonymous chatroom, the messaging server may determine, in operation 640, whether the first user account is under the family account. When the type of chatroom in which the remittance request is received is not the anonymous chatroom (e.g., a general chatroom), the messaging server may transmit, in operation 660, the remittance request regardless of whether the first user account is under the family account or regardless of a remittance condition.

According to an embodiment, the first user account is not under the family account, the remittance request from the first user account may not be processed, and the messaging server may transmit, in operation 670, a remittance failure notification to the terminal of the first user account.

According to an embodiment, when the first user account is under the family account, a remittance permission state may be determined, in operation 650, based on a set remittance condition. For example, when the administrator account of the family account sets that remittance is not allowed for the first user account, remittance is determined not to be allowed, and a remittance failure notification may be transmitted, in operation 670, to the first user account. As another example, when the administrator account of the family account sets a condition on a remittance limit for the first user account, and when a remittance amount according to the remittance request exceeds the condition on the remittance limit, remittance from the first user account may be determined not to be allowed, and a remittance failure notification may be transmitted, in operation 670, to the first user account.

According to an embodiment, when remittance is allowed according to the set remittance condition, the messaging server may transmit, in operation 660, the remittance request to the remittance server. For example, when remittance from the first user account is set to be allowed, and when the remittance amount according to the remittance request satisfies the condition on the remittance limit, the messaging server may transmit, in operation 660, the remittance request to the remittance server. As another example, when the condition on the remittance limit is not set, the remittance request may be processed based on the condition on whether remittance is allowed. Yet another example, when the condition on whether remittance is allowed is not set, the remittance request may be processed based on the condition on the remittance limit.

According to an embodiment, when the remittance request is transmitted to the remittance server, the method of providing a remittance service by the messaging server may further include receiving, from the remittance server, remittance transaction information corresponding to the remittance request generated based on a remittance limit set for the first user account by the family account.

According to an embodiment, the remittance condition on the remittance limit may be transmitted to the remittance server, and the remittance server may determine the condition on the remittance limit. In other words, the messaging server may transmit the remittance request to the remittance server regardless of a remittance amount when remittance is allowed after determining the remittance condition on whether remittance is allowed. The remittance server may compare the remittance amount of the remittance request with the condition on the remittance limit and determine whether remittance is allowed according to the condition on the remittance limit. When the requested remittance amount exceeds the remittance limit, the remittance server may notify the first user account that remittance is not processible. The remittance server may notify the messaging server that remittance is not processible, and the messaging server may transmit a remittance failure notification to the terminal of the first user account.

According to an embodiment, the method of providing a remittance service by the messaging server may further include receiving, from the remittance server, remittance transaction information including the second user account as a remittee and transmitting a remittance notification message to the second user account, based on the remittance transaction information. The remittance notification message and the remittance failure notification message are described in detail below.

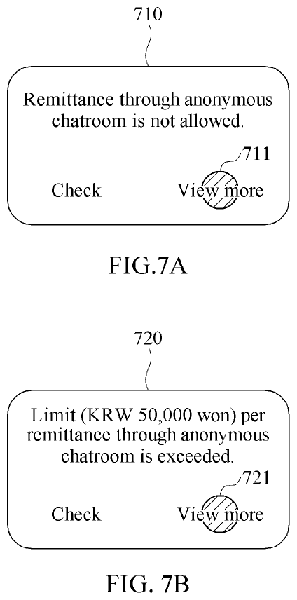

FIGS. 7A and 7B are diagrams each illustrating a remittance notification message on a remittance failure, according to an embodiment.

Referring to FIG. 7A, when an administrator account of a family account sets a remittance condition that does not allow remittance through an anonymous chatroom for a member account, a messaging server may transmit, in operation 710, the member account requesting remittance through the anonymous chatroom to a terminal of the member account. A remittance failure notification message 710 may include a notification message saying, “Remittance through anonymous chatroom is not allowed”.

According to an embodiment, the remittance failure notification message 710 may include an interfacing object 711 for checking a remittance condition. The terminal of the member account may enter an interface (e.g., the interface 330 of FIG. 3C) for checking the remittance condition set for the account of its own by the administrator account of the family account through the interfacing object 711 of the remittance failure notification message 710.

According to an embodiment, a guide message of a remittance failure notification message may vary depending on a remittance condition limiting a remittance request. For example, referring to FIG. 7B, when the remittance request is not processed according to a condition on a limit per remittance, the messaging server may transmit a remittance failure notification message 720 to the terminal of the member account requesting remittance through the anonymous chatroom. The remittance failure notification message 720 may include a notification message saying, “Limit (KRW 50,000) per remittance through anonymous chatroom is exceeded”.

As another example, when the remittance request is not processed according to a condition on a remittance limit per day, a remittance failure notification message transmitted to the terminal of the member account may include a guide message saying, “Remittance through anonymous chatroom exceeds limit (KRW 100,000) per day”.

According to an embodiment, the remittance failure notification message 720 may include an interfacing object 721 for checking a remittance condition. The terminal of the member account may enter an interface (e.g., the interface 330 of FIG. 3C) for checking the remittance condition set for the account of its own by the administrator account of the family account through the interfacing object 721 of the remittance failure notification message 720.

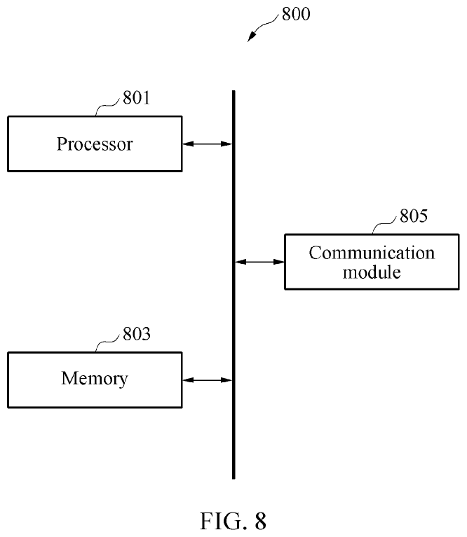

FIG. 8 is a diagram illustrating a configuration of a server according to an embodiment. Referring to FIG. 8, a server 800 may include a processor 801, a memory 803, and a communication module 805. The server 800 may include the server or the messaging server described above with reference to FIGS. 1 to 7.

The processor 801 may perform at least one operation described above with reference to FIGS. 1 to 7.

For example, the processor 801 may perform the operation method of the server providing a remittance service including generating a family account including at least one of an administrator account and at least one member account, in operation 110, in response to a request to generate the family account described above with reference to FIG. 1, receiving, from a terminal of the administrator account, a request to set a remittance condition for the at least one member account in operation 120, and processing a remittance request of the at least one member account, based on the remittance condition set for the at least one member account, in operation 130.

As another example, the processor 801 may perform the method of providing a remittance service by the messaging server for providing a messaging service by interoperating with the remittance server including receiving, from a terminal of a first user account subscribing to the messaging service described above with reference to FIG. 5, a remittance request to a second user account subscribing to the messaging service in operation 510, determining whether the first user account is under a family account, in operation 520, when the first user account is an account of a ward, determining whether remittance is allowed to the first user account, in operation 530, based on a remittance condition set for the first user account under the family account, and transmitting the remittance request to the remittance server, in operation 540, when remittance is allowed.

The memory 803 may be a volatile or non-volatile memory and may store data regarding the method of providing the remittance service described above with reference to FIGS. 1 to 7. For example, the memory 803 may store data generated in a process of providing the remittance service or data necessary for providing the remittance service. For example, the memory 803 may store data regarding accounts subscribing to a service, a family account, and remittance conditions set for member accounts by an administrator account of the family account.

The communication module 805 may provide a function for the server 800 to communicate with other electronic devices or other servers through a network. In other words, the server 800 may be connected to an external device (e.g., a terminal of a user account, server, or network) through the communication module 805 and exchange data therewith. For example, the server 800 may transmit and receive data to and from other servers and clients included by a remittance system (e.g., the remittance system of FIG. 4) through the communication module 805.

According to an embodiment, the memory 803 may store a program implementing the method of providing a remittance service by a messaging server for providing a messaging service by interoperating with a remittance server and/or the operating method of a server for providing the remittance service described above with reference to FIGS. 1 to 7. The processor 801 may execute the program stored in the memory 803 and may control the server 800. Code of the program executed by the processor 801 may be stored in the memory 803.

The server 800 may further include components not shown in the drawings. For example, the server 800 may further include an input/output interface including an input device and an output device as the means of interfacing with the communication module 805. In addition, for example, the server 800 may further include other components, such as a transceiver, various sensors, and a database.

The examples described herein may be implemented by using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of providing a remittance service by a messaging server for providing a messaging service by interoperating with a remittance server, the method comprising:
receiving, from a terminal of a first user account subscribing to the messaging service, a remittance request to a second user account subscribing to the messaging service;
determining whether the first user account is under a family account when the first user account is an account of a ward;
determining whether remittance is allowed to the first user account, based on a remittance condition set for the first user account under the family account; and
transmitting the remittance request to the remittance server when remittance is allowed.

2. The method of claim 1, wherein
the determining whether the first user account is under the family account comprises:
determining whether the first user account is under the family account, based on a type of chatroom through which the remittance request is received.

3. The method of claim 1, wherein
the determining whether the first user account is under the family account comprises:
determining whether the first user account is under the family account, based on a profile type of the second user account designated as a remittee of the remittance request.

4. The method of claim 1, further comprising:
receiving, from the remittance server, remittance transaction information corresponding to the remittance request generated based on a remittance limit set for the first user account by the family account.

5. The method of claim 1, wherein
the remittance condition is set for a member account of the family account by an administrator account of the family account.

6. The method of claim 1, wherein
the determining whether remittance is allowed comprises:
determining whether remittance is allowed through a chatroom through which the remittance request is received, based on the remittance condition on whether remittance is allowed; and
determining whether a remittance amount comprised by the remittance request is allowed to be remitted, based on the remittance condition on a remittance limit.

7. The method of claim 1, further comprising:
receiving, from the remittance server, remittance transaction information comprising the second user account as a remittee; and
transmitting a remittance notification message to the second user account, based on the remittance transaction information.

8. An operation method of a server providing a remittance service, the operation method comprising:
generating a family account comprising at least one of an administrator account and at least one member account in response to a request to generate the family account;
receiving, from a terminal of the administrator account, a request to set a remittance condition for the at least one member account; and
processing a remittance request of the at least one member account, based on the remittance condition set for the at least one member account.

9. The operation method of claim 8, wherein
the administrator account comprises an account of a guardian authenticated as an adult, and
the at least one member account comprises an account of a ward.

10. The operation method of claim 8, wherein
the generating the family account comprises:
authenticating whether a user account requesting the generation of the family account is an adult;
generating the family account comprising the adult authenticated user account as the administrator account;
transmitting an invitation request to a terminal of a user account designated as the at least one member account of the family account by the administrator account; and
adding a user account accepting the invitation request as the at least one member account of the family account.

11. The operation method of claim 8, wherein
the remittance condition comprises:
whether to allow remittance through a preset type of chatroom;
a remittance limit amount per day through the preset type of chatroom; and
a remittance limit amount per remittance through the preset type of chatroom.

12. A non-transitory computer-readable storage medium storing instructions that, when executed by a processor, cause the processor to perform the method of claim 1.

13. A messaging server providing a remittance service by interoperating with a remittance server, the messaging server comprising at least one processor configured to
receive, from a terminal of a first user account subscribing to a messaging service, a remittance request to a second user account subscribing to the messaging service,
determine whether the first user account is under a family account when the first user account is an account of a ward;
determine whether remittance is allowed to the first user account, based on a remittance condition set for the first user account under the family account; and
transmit the remittance request to the remittance server when remittance is allowed.

14. The messaging server of claim 13, wherein
the processor is configured to, when determining whether the first user account is under the family account,
determine whether the first user account is under the family account, based on a type of chatroom through which the remittance request is received.

15. The messaging server of claim 13, wherein
the processor is configured to, when determining whether the first user account is under the family account,
determine whether the first user account is under the family account, based on a profile type of the second user account designated as a remittee of the remittance request.

16. The messaging server of claim 13, wherein the processor is configured to
receive, from the remittance server, remittance transaction information corresponding to the remittance request generated based on a remittance limit set for the first user account by the family account.

17. The messaging server of claim 13, wherein the remittance condition is set for a member account of the family account by an administrator account of the family account.

18. The messaging server of claim 13, wherein
the processor is configured to, when determining whether remittance is allowed,
determine whether remittance is allowed through a chatroom through which the remittance request is received, based on the remittance condition on whether remittance is allowed, and
determine whether a remittance amount comprised by the remittance request is allowed to be remitted, based on the remittance condition on a remittance limit.

19. The messaging server of claim 13, wherein the processor is configured to
receive, from the remittance server, remittance transaction information comprising the second user account as a remittee, and
transmit a remittance notification message to the second user account, based on the remittance transaction information.

20. A server providing a remittance service, the server comprising at least one processor configured to
generate a family account comprising at least one of an administrator account and at least one member account in response to a request to generate the family account,
receive, from a terminal of the administrator account, a request to set a remittance condition for the at least one member account, and
process a remittance request of the at least one member account, based on the remittance condition set for the at least one member account.
